(19) United States
(12) Patent Application Publication
(10) Pub. No.: US 2009/0127761 A1
(43) Pub. Date: May 21, 2009

(54) Spacing Device Secured Against Extraction

(75) Inventor: Stephane Perche, Saint Bardoux (FR)

Correspondence Address: OLIFF & BERRIDGE, PLC, P.O. BOX 320850, ALEXANDRIA, VA, 22320-4850, US

(73) Assignee: EXSTO, Romans sur Isere (FR)

(21) Appl. No.: 12/084,201

(22) PCT Filed: Nov. 2, 2006
(86) PCT No.: PCT/FR2006/002448

§ 371 Date: Jul. 23, 2008

(30) Foreign Application Priority Data
Nov. 15, 2005 (FR) 0511542

(51) Int. Cl. B23Q 1/26

(52) U.S. Cl. 269/47; 269/329

(57) ABSTRACT

The present invention relates to a device for temporarily spacing an opening element with respect to a fixed element of a motor vehicle body, comprising, on the one hand, a fastening plate and, on the other hand, a stop element adapted to serve as a bearing support for the opening element, where the fastening plate is designed so as to engage with a wall of the fixed element, thereby blocking the spacing device in at least one direction, and in that said device has at least a second fastening point situated at a distance from the fastening plate and designed so as also to engage with a wall of the fixed element, thereby providing retention at least in the additional direction or directions.

The present invention relates to a temporary spacing device designed to be inserted between an opening element and a fixed element of a motor vehicle body.

Before permanent attachment of an opening element, such as a door, a hood or a tailgate, among others, on a fixed element of a motor vehicle body, one generally carries out steps for applying one or several coatings, such as protective coatings or the application of a layer or paint. During such treatments, these opening elements are not yet equipped with permanent closing devices, such as locks.

For this reason, temporary spacing and locking devices are provided which make it possible to keep an opening element in a pseudo-closed position in relation to a fixed element to which it much be attached.

Documents FR 2 833 562 and EP 0 931 895 each describe a device of this type comprising, on one hand, a fixing plate designed to enable anchoring of the device in the fixed element, and on the other hand, a body attached to the fixing plate and forming a stop adapted to serve as a bearing support for the opening element.

In a device according to document FR 2 833 562, the fixing plate is immobilized in the vehicle body, with the help of a peg designed to penetrate an orifice of the vehicle body and a screw designed to go through an orifice of the fixing plate to be fixed in a tapped orifice of the vehicle body.

In a device according to document EP 0 931 895, the anchoring of the fixing plate is done via at least one tapped orifice arranged in the vehicle body and designed each to receive a peg integral with the fixing plate. One such peg is provided with peripheral fins able to cooperate with the corresponding tapped orifice when an operator exerts pressure on the temporary spacing device. A screw may be used as additional fixing means. The advantage of this type of fixing method is that it does not require any tools during assembly of the maintenance device. However, when the stresses to be bome are too great, it is appropriate to add a screw which itself does require a tool for its insertion.

Nevertheless, these two fixing systems have limits in bearing strong loads or repeated shocks, the fixing means being able to transmit significant stresses on the fixed structure, and as a result to damage the bodywork of the vehicle body if the stresses borne are too great, the damages being able to go as far as extraction of the fixing means.

The present invention aims to resolve the previously described drawback and to this end consists of a device for temporarily spacing an opening element on a fixed element of a motor vehicle body, comprising, on one hand, a fixing plate, and on the other hand, a stop element able to serve as a support for the opening element, characterized in that the fixing plate is designed so as to engage with a wall of the fixed element while blocking the spacing device along at least one direction, and in that said device has at least one second fixing point located away from the fixing plate and designed so as also to engage with a wall of the fixed element while providing retention at least in the additional direction(s).

By opening element is meant any vehicle body part, such as a door, a hood, or a tailgate, which is mobile in relation to the body of the motor vehicle.

Thus, providing a second remote anchoring point enables better distribution of the stresses exerted on the stop element. In this way, the stresses borne by the fixing means are decreased, which also makes it possible to use fixing means which are less massive, and therefore less expensive to manufacture.

The second anchoring point provides a fixing complement in the case where the fixing plate is designed only to maintain the spacing device along one or two directions, maintenance in the missing direction(s) to ensure good holding being provided by the second fixing point.

Although this second fixing point is not strictly necessary for maintaining the device in the case of fixing of the fixing plate with the help of screws ensuring fixing which is theoretically sufficient in all three directions, it does, however, ensure better distribution of stresses. In such a case, one could then use screws having a smaller diameter and therefore having a lower cost while also ensuring better resistance to stresses thanks to the distribution of efforts over several anchoring zones.

Advantageously, the second fixing point is designed so as to come to the level of an edge of the fixed structure.

According to a first preferred embodiment of the invention, the second fixing point forms a slot wherein the edge of the fixed structure can be introduced, said slot being made from a fixed part to which an elastically deformable retaining member is attached. An embodiment of this type does not require a corresponding orifice arranged in a wall of the fixed structure, and is particularly easy to insert and remove thanks to the elastic retaining member by simple separation thereof.

According to a second embodiment, the second fixing point comprises at least one fixing means designed to cooperate with a corresponding orifice of the fixed structure. Advantageously, at least one fixing means is of the clip-on type. Of course, one can use, in variation, any usual fixing means such as a screw, but also a fir tree fix or magnets, for example.

Preferably, the fixing plate is equipped with maintenance means able to cooperate by interlocking with corresponding openings of the fixed structure. Fixing by simple interlocking makes it possible to insert the spacing device according to the invention without using tools, the additional maintenance needed to stabilize the interlocking being provided by the second fixing point.

Advantageously, the fixing means of the fixing plate comprise at least one retaining member forming a lip. Also advantageously, the fixing means are completed by at least one positioning finger.

In variation, the fixing means provided can be of the clip-on type.

Advantageously, the stop element is designed so as to be able to be housed between the fixed element and the opening element. Thus the stop element can come into contact with the opening element through a concealed area, designed to be covered by an internal covering element of the vehicle and therefore will not hurt the paint by leaving a mark on an unpainted area.

Preferably, the device is a single piece. Advantageously, the device according to the invention is made from a thermoplastic material able to bear a temperature at least equal to 180° C.

Implementation of the invention will be better understood with the help of the detailed description provided below with regard to the appended drawing in which:

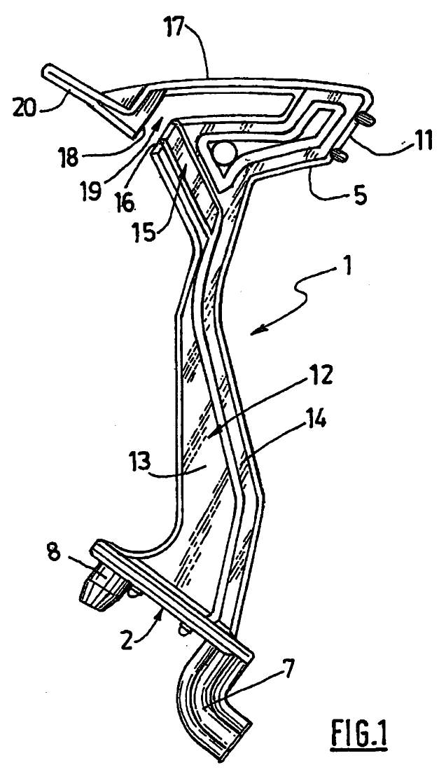

FIG. 1 is a perspective illustration of a first embodiment of a spacing device according to the invention designed to maintain a door in a pseudo-closed position in relation to a motor vehicle body.

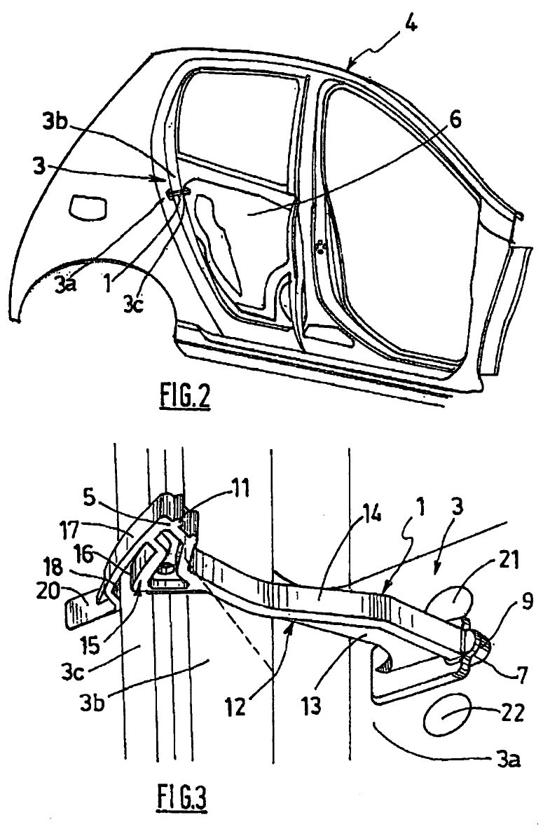

FIG. 2 is a view of the spacing device of FIG. 1 placed on a vehicle body.

FIG. 3 is a close-up front view of the spacing device illustrated in FIG. 2.

FIG. 4 is a close-up rear view of the spacing device illustrated in FIG. 2.

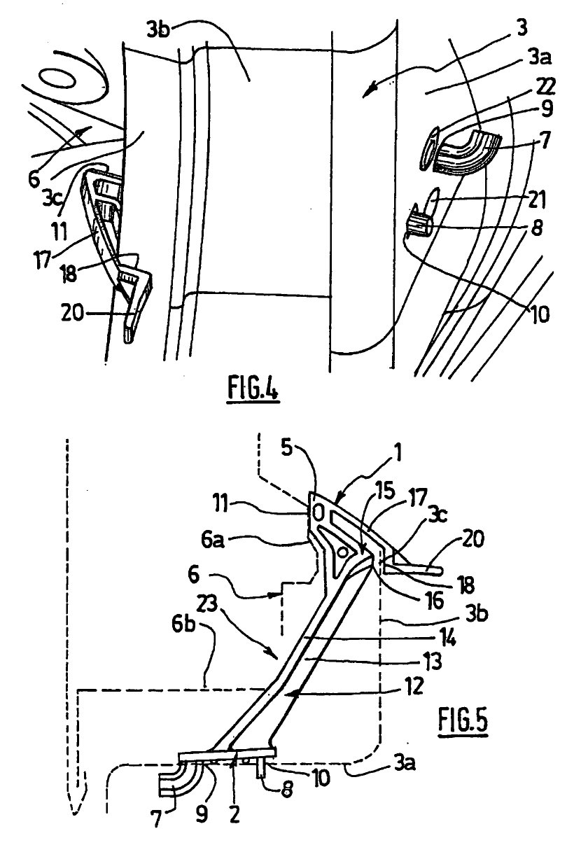

FIG. 5 is a diagrammatic longitudinal cross-section of the device of FIG. 1 inserted between a door and the vehicle body.

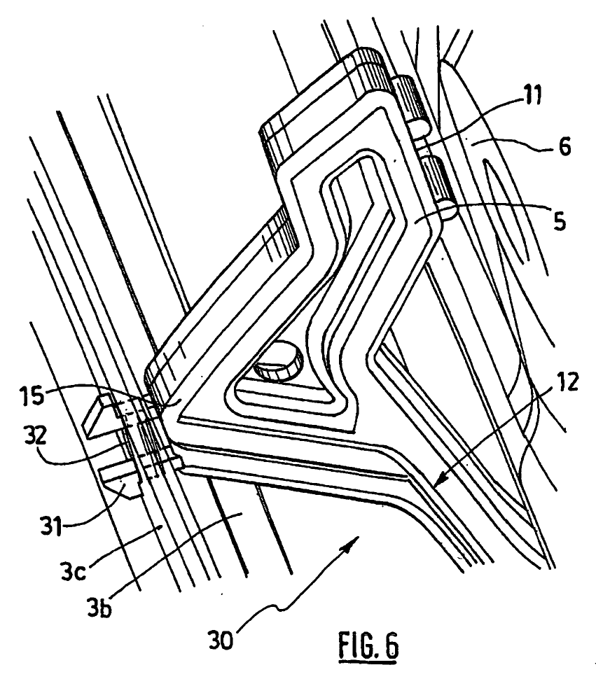

FIG. 6 is a partial perspective illustration of a spacing device according to a second embodiment of the invention.

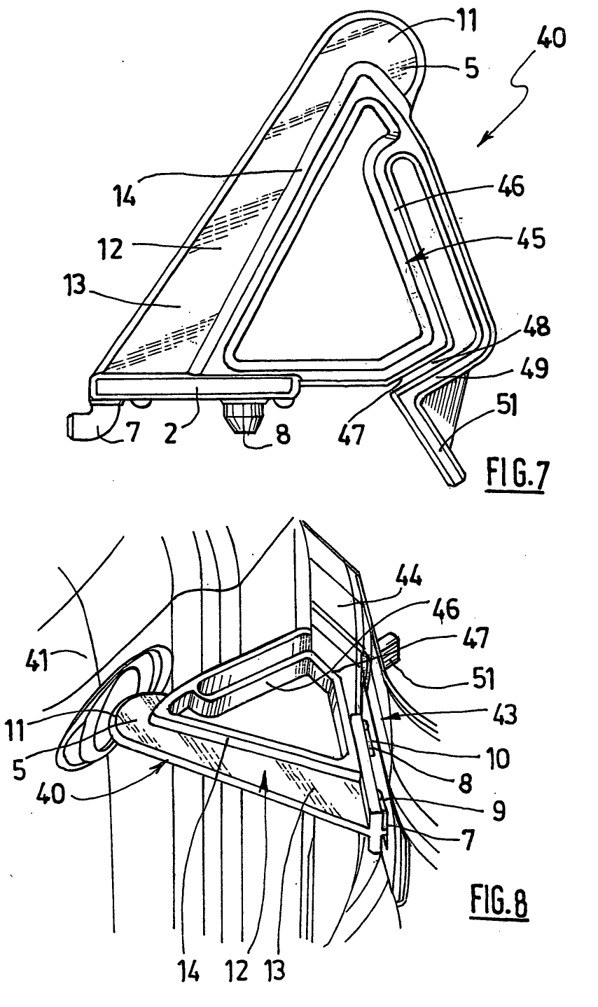

FIG. 7 is a side view of another embodiment of a spacing device according to the invention designed to maintain a tailgate in a pseudo-closed position in relation to the vehicle body.

FIG. 8 is a perspective illustration of the spacing device from FIG. 7 inserted on the vehicle body to maintain a motor vehicle tailgate.

In the following description, the same elements in the different embodiments bear the same references.

A temporary spacing device 1 according to the invention, as shown in FIGS. 1 to 5, comprises a single-piece body designed from a shaped thermoplastic material, broken down, on one hand, into a fixing plate 2 designed to enable temporary anchoring of the spacing device in a wall 3a of a fixed element 3 of a motor vehicle body 4, and on the other hand, a stop element 5 adapted to serve as a bearing support for an opening element, in this case a door 6.

The fixing plate 2 is equipped with attaching means comprising, on one hand, a retaining member having a curved end forming a lip 7, and on the other hand, a positioning finger 8, each designed to be inserted in a corresponding orifice 9, 10 of the wall 3a of the fixed element 3. This is therefore a screw-free fixing system by interlocking of the fixing plate. Alternatively, one can provide a fixing system able to be clipped using removable clipping hooks or a clipping positioning finger, for example.

The stop element 5 is made in the form of a stiff protuberance having a contact surface 11 designed to come into contact with a wall of the door 6 and is attached to the fixing plate 2 with the help of an intermediate part 12 which is generally in the shape of a scorpion tail.

More precisely, the intermediate part 12 and the stop element 5 can be arranged so as to form a space able to receive a rim 6a of the opening element 6, the stop element 5 thus being able to come into contact with the door 6 in an area of said door 6 which is not visible.

The intermediate part 12 is made in the form of a core 13 contained in a plane perpendicular to the fixing plate 2, and a stiffening rim 14, perpendicular and transverse to the fixing plate 2, extending continuously along the edge of the core 13.

Potential: The intermediate part 12 grants the stop element 5 a certain flexibility enabling the spacing device 1 to absorb any shocks against the door 6 to a certain extent. The flexibility may be due to the material used and/or the thickness thereof, and/or the shape of the stiffening rim 14 in relation to the core 13.

Moreover, the spacing device 1 comprises a second fixing point 15 located away from the fixing plate 2 and designed to engage with a second wall 3b of the fixed element 3 substantially perpendicular to the wall 3a.

To do this, the stop element 5 has, on one hand, a second contact surface 16, oriented opposite the contact surface 11 designed to come into contact with the door 6, and on the other hand, a retaining member 17 elastically attached by a first end to a fixed part of the stop element 5 and having a second end forming a contact wall 18 substantially parallel to the second contact surface 16. The retaining member 17 and the second contact surface 16 together form a slot 19 designed to receive a rim 3c of the wall 3b of the fixed element 3, this rim commonly being called a rabbet. The retaining member 17 is extended by a pull tab 20 designed to facilitate its handling. It should be noted that the retaining member 17 must be long enough to retain the rabbet and have a wall against which the rabbet abuts in order to prevent any untimely exit thereof without voluntary separation of the retaining member 17 with the help of the pull tab.

A user wishing to position a door 6 in a separated position close to its closed position in relation to a fixed element 3 of a motor vehicle body with the help of a spacing device 1 according to the invention, will proceed as follows.

Initially, the fixed element 3 of the vehicle body is placed on an assembly chain along which it advances in order to undergo various assembly operations. This fixed element 3 has openings designed to receive opening elements, such as doors 6, a tailgate or a hood, among others. These openings each define, in relation to the fixed element 3 of the vehicle body, a plane, substantially vertical in the case of the door, in which the hinging direction is found. A fixed element of this type is illustrated in FIG. 2.

During these assembly operations, the doors 6 and other opening elements are mounted on the fixed element 3 with the help of suitable hinges. However, these opening elements are not yet equipped with permanent closing devices and locks. When the vehicle body is ready to receive an application of paint or a protective layer, the opening elements must be placed in a position close to their closed position, or pseudo-closed position, so as to cover all of the external parts of the vehicle body.

These opening elements are kept separated from the fixed structure 3 in this position with the help of the spacing device 1 according to the invention.

More precisely, the spacing device 1 is provided to be temporarily fixed on the fixed element 3, in the volume which will be occupied by the lock of the door 6, and comprising fixing points 21, 22 for a strike on the fixed element 3 and a corresponding housing 23 provided in the door 6 for said lock. This housing 23 is formed by a blank formed in an internal surface of the opening element and comprises a rim 6b extending perpendicular to the plane of the opening element and a rim 6a extending parallel to the plane of the opening element, i.e. to the wall 3b.

To do this, the curved end of the lip 7 of the fixing plate 2 is introduced in the corresponding orifice 9 of the wall 3a of the fixed structure 3, then the spacing device 1 is driven in rotational movement making it possible to cause the curved end of the lip 7 to engage with the wall 3a, position in which the positioning finger 8 is then inserted into the opening 10 devoted to it. The lip 7 and the positioning finger 8 enable maintenance in the plane of the fixed element 3, but a slight rotation of the device in a plane perpendicular to the plane of the fixed element enables easy disengagement of the retaining means constituted by the lip 7 and the positioning finger 8. Additional fixing must therefore be provided by the second fixing point 15. Of course, it is also possible to use fixing via screws, although this type of fixing has the drawback of requiring tools. In this case, one will use tapped orifices 21, 22 provided for the permanent lock. Also in this case, the second fixing point 15 provides an additional anchoring point enabling better distribution of stresses.

Thanks to the pull tab 20, the operator separates the elastic retaining member 17 so as to allow the passage of the rabbet 3a until said rabbet comes into contact with the second contact surface 16. The pull tab 20 is then released and the retaining member 17 returns to its resting position in which it forms, with the second contact surface 16, a slot housing the rabbet 3c and blocking any separation thereof. A rotational movement, which would make it possible to disengage the lip 7 and the positioning finger 8, is therefore prevented.

The spacing device 1 thus being placed, the door 6 is then brought to its pseudo-closed position such that it bears on the contact surface 11 of the stop element 5.

Once the coating or paint has been applied, the spacing devices 1 are removed and the permanent closing devices as well as the locks can be installed.

FIG. 6 shows a second embodiment of a spacing device 30 according to the invention. This spacing device 30 is different from the spacing device 1 previously described only in that the second fixing point is made in the form of a clip 31 integral with the stop element 5 and designed to cooperate with a corresponding orifice 32 of the fixed element 3. Another variation of embodiment resides in the use of a screw designed to cooperate with a tapped bore of the wall 3b.

FIGS. 7 and 8 present a spacing device 40 according to the invention designed to maintain a tailgate 41 on a vehicle body.

The vehicle body has a continuous wall 43 having a curved end 44.

A spacing device 40 of this type is different from the spacing device previously described in that it comprises a second fixing point 45 formed in the shape of a square 46 located between the stop element 5 and the fixing plate 2 and having a contact surface 47 designed to come into contact with the curved end 44 of the wall 43 of the fixed structure, this contact surface 47 forming a slot 48 with a stiff retaining member 49 elastically connected to the square 46. A pull tab 51 is provided on the retaining member 49. As for the spacing device 1 previously described, the spacing device 40 is inserted with the help of the fixing plate 2 as previously described, then is maintained thanks to the second fixing point 45 engaging with the curved end 44 of the wall 43 thanks to the slot 48 formed by the retaining member 49 and the contact surface 47 of the square 46. The second fixing point 45 is fixed as for the spacing device 1 by separating the elastic retaining member 49 with the help of the pull tab 51.

Although the invention has been described in connection with particular examples of embodiments, it is obviously in no way limited and includes all technical equivalents of the described means as well as their combinations if these fall within the scope of the invention.

1. Temporary spacing device for an opening element on a fixed element of a motor vehicle body, comprising, on one hand, a fixing plate, and on the other hand, a stop element adapted to serve as a bearing support for the opening element, wherein the fixing plate is designed so as to engage with a wall of the fixed element thereby blocking the spacing device in at least one direction, and in that said device has at least one second fixing point located away from the fixing plate and designed so as also to engage with a wall of the fixed element, thereby providing retention at least in the additional direction(s).

2. Temporary spacing device according to claim 1, wherein the second fixing point is designed so as to come to the level of an edge of the fixed structure.

3. Temporary spacing device according to claim 2, wherein the second fixing point forms a slot in which the edge of the fixed structure can be introduced, said slot being made from a fixed part whereto is attached an elastically deformable retaining member.

4. Temporary spacing device according to claim 1, wherein the second fixing point comprises at least one fixing means designed to cooperate with a corresponding orifice of the fixed structure.

5. Temporary spacing device according to claim 4, wherein at least one fixing means is able to be clipped.

6. Temporary spacing device according to claim 1, wherein the fixing plate is equipped with maintenance means able to cooperate by interlocking with corresponding openings of the fixed structure.

7. Temporary spacing device according to claim 6, wherein the fixing means of the fixing plate comprise at least one retaining member forming a lip.

8. Temporary spacing device according to claim 7, wherein the fixing means are completed by at least one positioning finger.

9. Temporary spacing device according to claim 1, wherein the stop element is designed so as to be able to be housed between the fixed element and the opening element.

10. Temporary spacing device according to claim 1, wherein it is a single piece.
